(19) United States
(12) Patent Application Publication
(10) Pub. No.: US 2017/0237457 A1
(43) Pub. Date: Aug. 17, 2017

(54) MILLIMETRE WAVE TRANSCEIVER

(71) Applicant: Filtronic Broadband Limited, Sedgefield (GB)

(72) Inventor: Andrew Tucker, Richmond (GB)

(21) Appl. No.: 15/429,259

(22) Filed: Feb. 10, 2017

(30) Foreign Application Priority Data
Feb. 12, 2016 (GB) 1602524.9

(51) Int. Cl. H04B 1/38; H04L 25/03; H04L 5/02; H04L 5/00; H04L 5/04

(52) U.S. Cl. CPC H04B 1/38; H04L 5/0048; H04L 5/04; H04L 5/023; H04L 25/03847

(57) ABSTRACT

A millimetre wave transceiver includes a multiplexer having a pair of transmit ports, receive ports and antenna ports, an antenna, an orthomode transducer, a pair of modulators each providing a transmit signal at the same frequency and receiving a carrier signal from a local oscillator and a data signal and modulating the carrier signal with the data signal to produce the transmit signal and providing its transmit signal to a corresponding transmit port of the multiplexer, a pair of demodulators each receiving a receive signal at the same frequency from a corresponding receive port and a reference signal from a local oscillator, and demodulating the receive signal at a frequency related to the reference signal to obtain a data signal, wherein at least one of the modulators are connected to a common local oscillator, and the demodulators are connected to a common local oscillator.

The present invention relates to a millimetre wave transceiver. More particularly, but not exclusively, the present invention relates to a millimetre wave transceiver comprising a pair of modulators and a pair of demodulators wherein at least one of the pair of modulators and pair of demodulators is connected to a common local oscillator.

Millimetre wave transceivers are known. Such millimetre wave transceivers typically comprise a modulator which receives a carrier signal from an oscillator and modulates it with a data signal. The modulated signal is then passed to a multiplexer and then to an antenna. The transceiver also comprises a demodulator connected to the multiplexer. The demodulator demodulates signals received by the antenna to extract a data signal.

It is often desired to maximise the amount of data that can be transmitted and received within a narrow frequency range. In order to achieve this transceivers are known which comprise a pair of modulators (and demodulators). The modulators modulate separate data signals onto the same carrier frequency. The two modulated signals are horizontally and vertically polarised before being passed to the antenna. The two polarised signals can then be separated by a receiver and demodulated separately. Each modulator receives a carrier signal from its own local oscillator.

Oscillators draw a significant amount of power. Whilst this is not a problem for ground based millimetre wave transceivers this arrangement is unsuitable for millimetre wave transceivers which are to be deployed in power constrained environments, for example avionic applications.

The present invention seeks to overcome the problems of the prior art.

Accordingly, the present invention provides a millimetre wave transceiver comprising a multiplexer comprising a pair of transmit ports, a pair of receive ports and a pair of antenna ports;

an antenna;

an orthomode transducer connected between the antenna ports and the antenna;

a pair of modulators each of which provides a transmit signal at the same frequency, each modulator adapted to receive a carrier signal from a local oscillator and a data signal and to modulate the carrier signal with the data signal to produce the transmit signal, each modulator being arranged to provide its transmit signal to a corresponding transmit port of the multiplexer;

a pair of demodulators, each demodulator being adapted to receive a receive signal at the same frequency from a corresponding receive port of the multiplexer and a reference signal from a local oscillator, and to demodulate the receive signal at a frequency related to the reference signal to obtain a data signal,

characterised in that

at least one of (a) the pair of modulators are connected to a common local oscillator, and (b) the pair of demodulators are connected to a common local oscillator.

The millimetre wave transducer according to the invention requires fewer local oscillators than known millimetre wave transducers. It therefore draws less power and is more suitable for deployment in power constrained environments, for example avionic applications.

Preferably the pair of modulators are connected to a common local oscillator and the pair of demodulators are connected to a further common local oscillator.

Alternatively the pair of modulators are connected to a common local oscillator and each of the demodulators in the pair of demodulators is connected to a different local oscillator.

In a further alternative the pair of demodulators are connected to a common local oscillator and each of the modulators in the pair of modulators is connected to a different local oscillator.

Preferably the millimetre wave transceiver further comprises a circular polariser between the orthomode transducer and the antenna.

Preferably the orthomode transducer and circular polariser are integrated as a septum polariser.

Preferably the millimetre wave transceiver comprises a plurality of pairs of modulators, each modulator within a pair of modulators being adapted to provide a transmit signal at the same frequency, each pair of modulators being adapted to provide a transmit signal at a different frequency, wherein for at least one of the pairs of modulators the modulators are connected to a common local oscillator.

Preferably the millimetre wave transceiver comprises a plurality of pairs of demodulators, each demodulator within a pair being adapted to receive a receive signal at the same frequency from an associated receive port of the multiplexer, each pair of demodulators being adapted to demodulate a receive signal at a different frequency, wherein for at least one of the pairs of demodulators the demodulators are connected to a common local oscillator.

Preferably each transmit signal is amplified by an amplifier block prior to being passed to the multiplexer.

The present invention will now be described by way of example only and not in any limitative sense with reference to the accompanying drawings in which

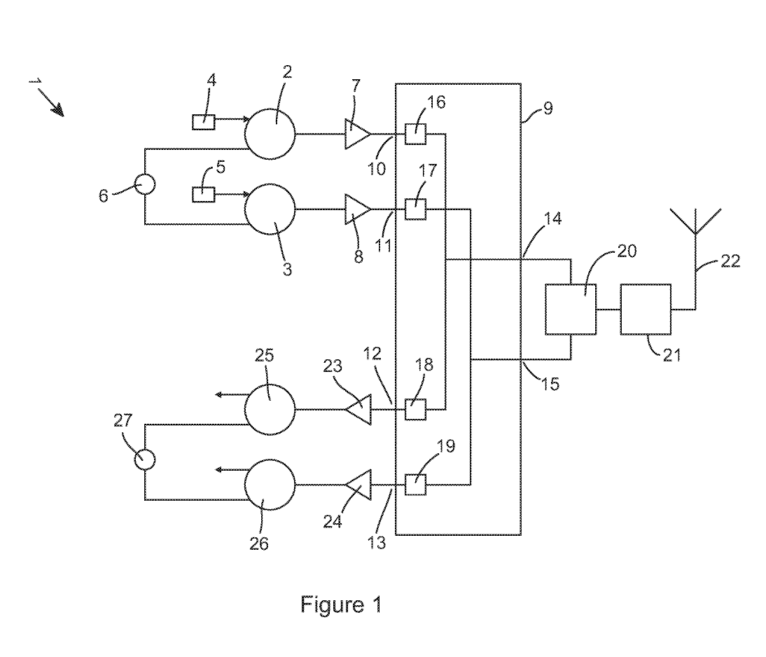

FIG. 1 shows a first embodiment of a millimetre wave transceiver according to the invention in schematic form;

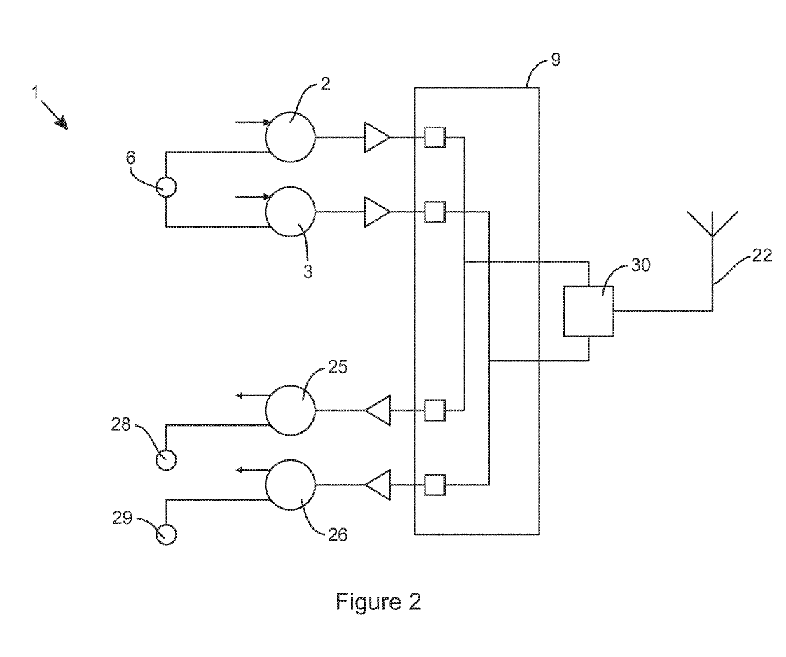

FIG. 2 shows a further embodiment of a millimetre wave transceiver according to the invention;

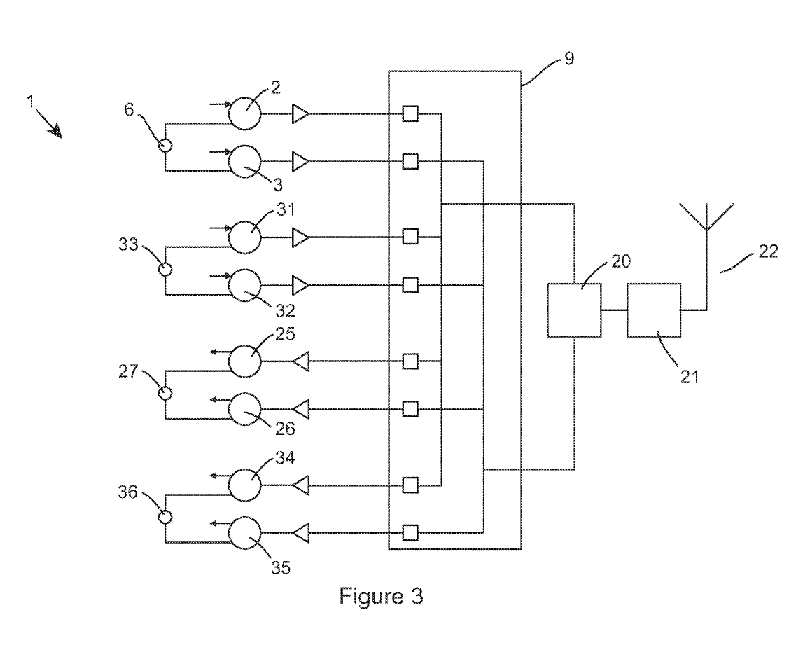

FIG. 3 shows a further embodiment of a millimetre wave transceiver according to the invention;

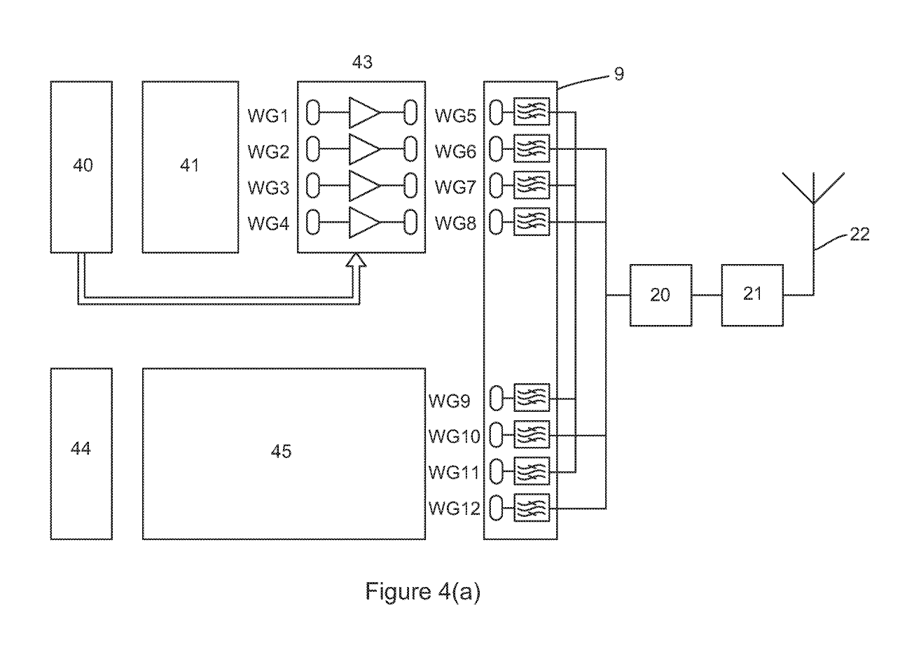

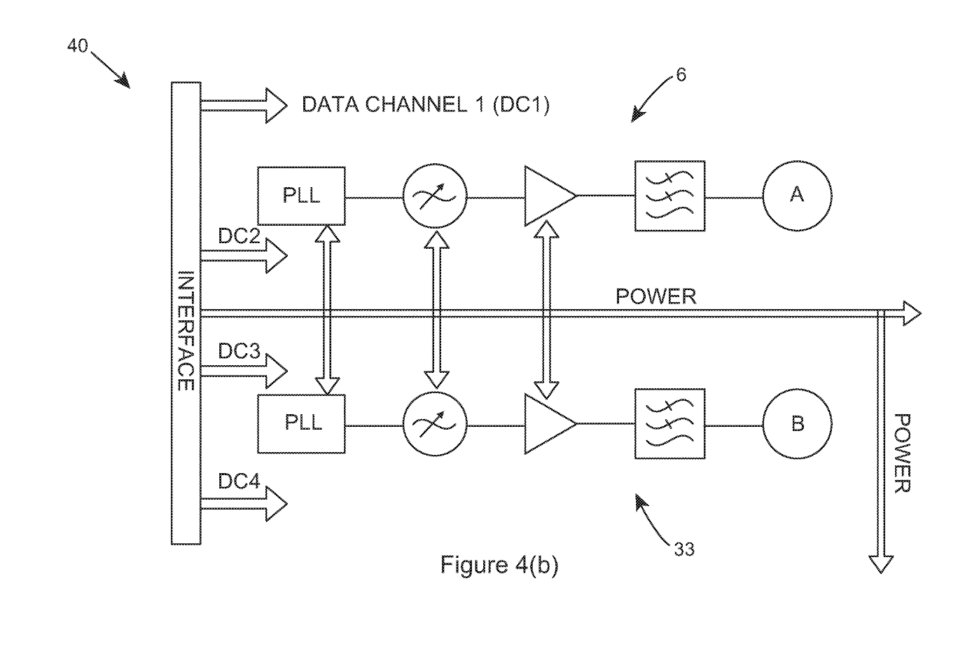

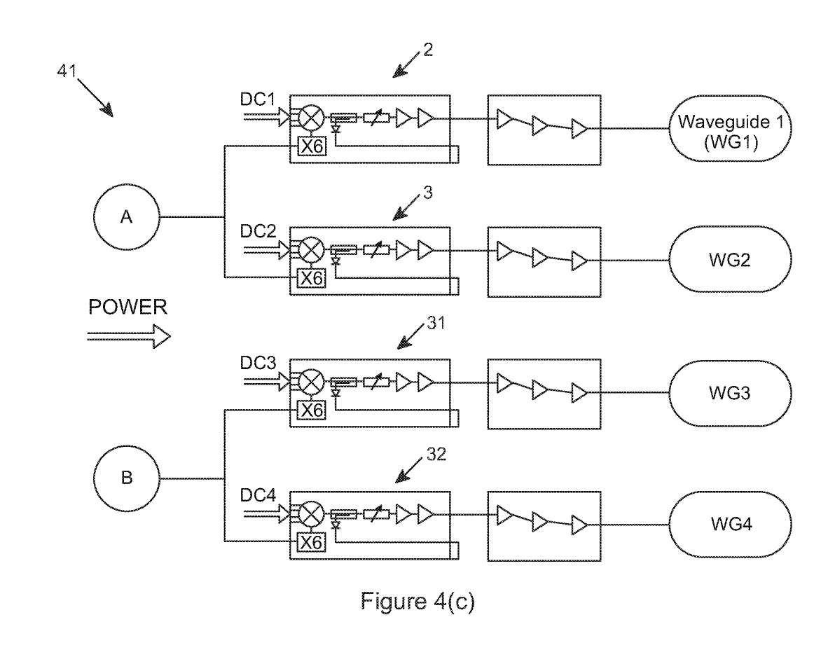

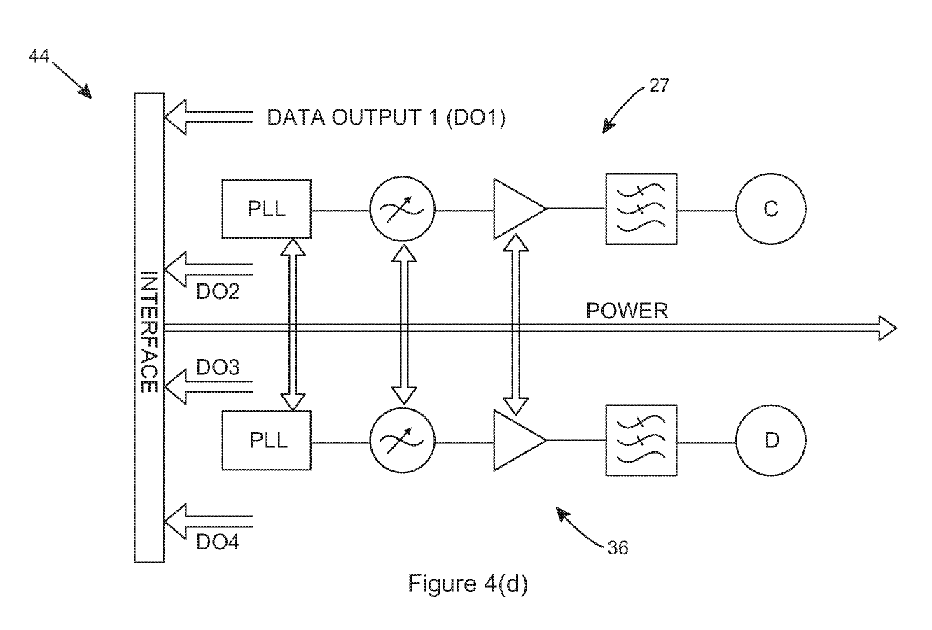

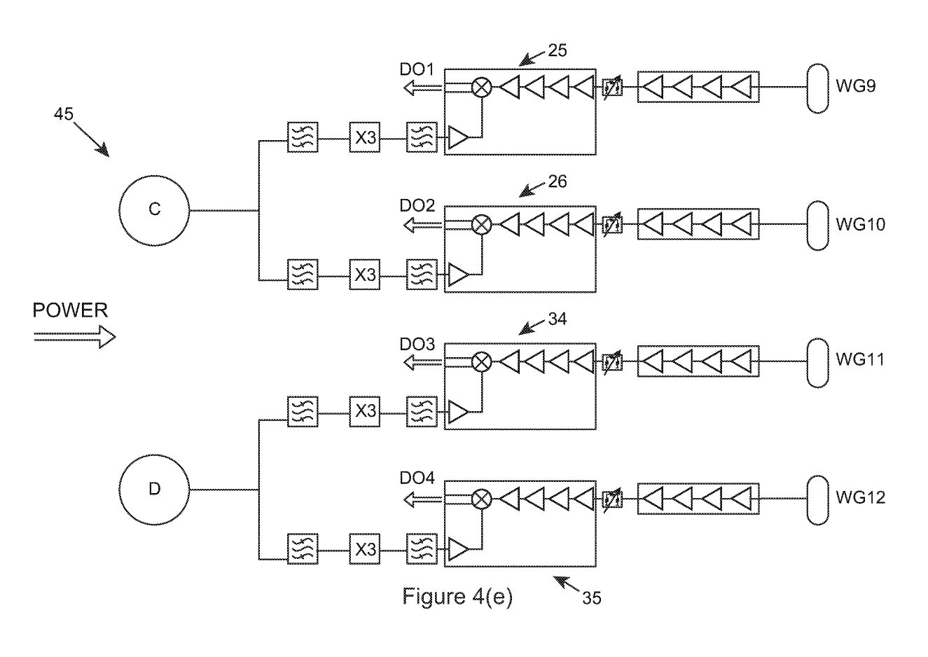

FIG. 4(a) shows a further embodiment of a millimetre wave transceiver according to the invention;

FIGS. 4(b) to 4(e) show components of the millimetre wave transceiver of FIG. 4(a) in more detail; and,

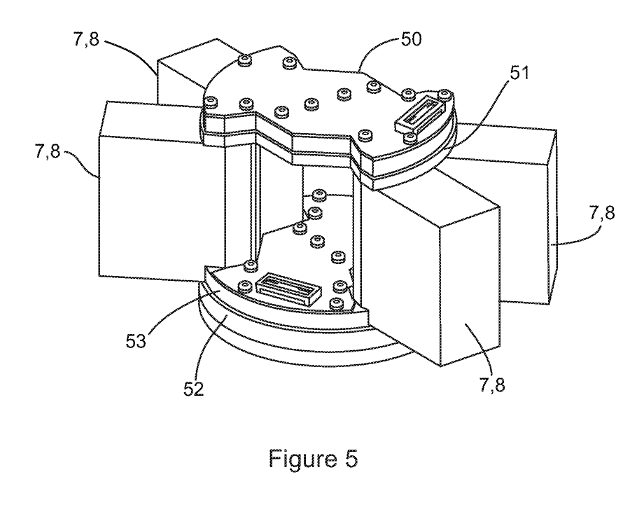

FIG. 5 shows a further embodiment of a millimetre wave transceiver according to the invention in perspective view.

Shown in FIG. 1 is a millimetre wave transceiver 1 according to the invention. The millimetre wave transceiver 1 comprises first and second modulators 2,3 which together form a modulator pair. Each modulator 2,3 receives a data signal from a data source 4,5 and a carrier signal from a common local oscillator 6. The two modulators 2,3 of the modulator pair share the same common local oscillator 6. Each modulator 2,3 modulates the carrier signal it receives from the local oscillator 6 with its data signal to produce a transmit signal. The two transmit signals are at the same frequency.

The two transmit signals are then passed to amplifier blocks 7,8. The amplifier blocks 7,8 amplify the transmit signals before passing them to a multiplexer 9.

The multiplexer 9 comprises a pair of transmit ports 10,11, a pair of receive ports 12, 13 and a pair of antenna ports 14,15. Each antenna port 14,15 is connected to a corresponding transmit port 10,11 and receive port 12,13 by millimetre waveguides 14,15 as shown. Connected to each transmit port 10,11 is a transmit filter 16,17. The transmit filter 16,17 has a bandpass which allows a transmit signal to pass from a transmit port 10,11 through the transmit filter 16,17 to the corresponding antenna port 14,15. Connected to each receive port 12,13 is a receive filter 18,19. The receive filter 18,19 has a bandpass which allows a receive signal received from the antenna to pass from the antenna ports 14,15 through the receive filter 18,19 to the receive ports 12,13. The bandpasses of the transmit filters 16,17 do not overlap with the bandpasses of the receive filters 18,19. The filters 16,17,18,19 are typically realised by means of cavity resonators or the like as is known in the art.

The amplified signals from the amplifier blocks 7,8 are passed to the transmit ports 10,11 of the multiplexer 9. From there they pass through the transmit filters 16,17 to the antenna ports 14,15 of the multiplexer 9 and to the receive filters 18,19. They do not pass through the receive filters 18,19. From the antenna ports 14,15 the two transmit signals pass to the input ports of an orthomode transducer 20. The orthomode transducer 20 vertically polarises one transmit signal and horizontally polarises the other and combines them on the same signal line. The two polarised transmit signals are then passed to a circular polariser 21 which combines the two transmit signals into a single circularly polarised transmit signal which is then passed to the antenna 22.

When the antenna 22 receives a circularly polarised receive signal this is passed to the circular polariser 21 which splits the receive signal into vertically and horizontally polarised receive signals. These are passed on the signal line to the orthomode transducer 20 which splits them onto separate lines. The two receive signals are then passed to the antenna ports 14,15 of the multiplexer 9. From the antenna ports 14,15 the receive signals are passed to the transmit filters 16,17 and the receive filters 18,19. The receive signals pass through the receive filters 18,19 to the receive ports 12,13 of the multiplexer 9. The receive signals do not pass through the transmit filters 16,17.

From the receive ports 12,13 of the multiplexer 9 the receive signals are amplified by low noise amplifiers 23,24 before being passed to a pair of demodulators 25,26. The demodulators 25,26 each receive a reference signal from a common local oscillator 27. Each demodulator 25,26 demodulates its received receive signal at a frequency related to the reference signal to produce a data signal. Techniques of demodulation are well known to one skilled in the art and are not explained in detail.

The millimetre wave transceiver 1 transmits and receives signals in the millimetre waveband. Typically this is in the range 30-300 GHz. Preferably the signals are in the E band range ie in the range 71-86 GHz.

The millimetre wave transceiver 1 is typically employed as part of a pair which between them provide a data link. The data link can for example be a terrestrial data link, an aircraft to satellite link or an aircraft to aircraft link. One transceiver 1 transmits at a high frequency and receives at a low frequency. The other transceiver 1 transmits at the low frequency and transmits at the high frequency.

Circular polarisation of the transmission signals before transmission has an important technical benefit in cases where in use the one of the pair moves with respect to the other (for example with a terrestrial to airborne data link). With conventional millimetre wave transceivers which transmit horizontally and vertically polarised transmit signals at the same frequency the distinction between the two signals can be lost when the receiver moves with respect to the transmitter. If the transmit signals are circularly polarised motion of the receiver with respect to the transmitter is of no consequence.

Shown in FIG. 2 is a further embodiment of a millimetre wave transceiver 1 according to the invention. The embodiment of FIG. 2 is similar to that of FIG. 1 except the demodulators 25,26 each obtain their reference signals from separate local oscillators 28,29. The local oscillators 28,29 oscillate at the same frequency. This embodiment requires more oscillators than the embodiment of FIG. 1.

Further, in this embodiment the orthomode transducer and circular polariser are integrated into a septum polariser 30.

Shown in FIG. 3 is a further embodiment of a millimetre wave transceiver 1 according to the invention. This embodiment comprises a first pair of modulators 2,3 which employ a common local oscillator 6 to provide transmit signals at a first frequency. This embodiment further comprises a second pair of modulators 31,32 which employ a further common local oscillator 33 to provide transmit signals at a second frequency. The transceiver comprises corresponding first and second pairs of demodulators 25,26,34,35 as shown, the demodulators in each pair employing a common local oscillator 27,36.

FIG. 4(a) shows a further embodiment of a millimetre wave transceiver 1 according to the invention. The transceiver 1 comprises a transmitter control board 40. The transmit control board provides the local oscillators 6,33 for the multiplexers 2,3,31,32 and also power to other parts of the transceiver 1. The transmitter control board 40 is shown in more detail in FIG. 4(b). The transmitter module 41 receives the carrier signals from the oscillators 6,33 of the transmitter control board 40, modulates them with data signals to produce the transmit signals which are then passed to the amplifier module 43. The transmitter module 41 is shown in more detail in FIG. 4(c). The amplifier module 43 passes the amplified transmit signals to the multiplexer 9, orthomode transducer 20, circular polariser 21 and antenna 22 as previously described.

The transceiver 1 further comprises a receiver control board 44. The receiver control board 44 contains oscillators 27, 36 for use by the receiver module 45. The receiver module 45 comprises demodulators 25,26. The demodulators 25,26 receive the receive signals from the multiplexer 9 and demodulate them employing the reference signals from the oscillators 27, 36 as previously described. The receiver control board 44 is shown in more detail in FIG. 4(d). The receiver module 45 is shown in more detail in FIG. 4(e).

Shown in FIG. 5 in perspective view is an embodiment of a millimetre wave transceiver 1 according to the invention. The top layer 50 comprises the local oscillators 6,33 for the modulators 2,3,31,32. The modulators 2,3,31,32 are arranged in the modulator layer 51 below. Extending from the modulator layer 51 are four power amplifiers 7,8. In this embodiment the transceiver 1 has four modulators 2,3,31,32 and so requires four power amplifiers 7,8. The four power amplifiers 7,8 are connected to the multiplexer layer 52. Arranged on the multiplexer layer 52 is the demodulator layer 53 comprise the demodulators 25,26,34,35 and associated circuitry. The local oscillators 27,36 for the demodulators 25,26,34,35 are arranged on the demodulator layer 53.

1. A millimetre wave transceiver comprising:
a multiplexer comprising a pair of transmit ports, a pair of receive ports and a pair of antenna ports;
an antenna;
an orthomode transducer connected between the pair of antenna ports and the antenna;
a pair of modulators each of which provides a transmit signal at the same frequency, each one of the pair of modulators adapted to receive a carrier signal from a local oscillator and a data signal and to modulate the carrier signal with the data signal to produce the transmit signal, each one of the pair of modulators being arranged to provide its transmit signal to a corresponding one of the pair of transmit ports of the multiplexer;
a pair of demodulators, each one of the pair of demodulators being adapted to receive a receive signal at the same frequency from a corresponding one of the pair of receive ports of the multiplexer and a reference signal from the local oscillator, and to demodulate the receive signal at a frequency related to the reference signal to obtain a data signal, wherein at least one of (a) the pair of modulators are connected to a common local oscillator; and (b) the pair of demodulators are connected to the common local oscillator.

2. A millimetre wave transceiver as claimed in claim 1, wherein the pair of modulators are connected to the common local oscillator and the pair of demodulators are connected to a further common local oscillator.

3. A millimetre wave transceiver as claimed in claim 1, wherein the pair of modulators are connected to the common local oscillator and each one of the pair of demodulators is connected to a different local oscillator.

4. A millimetre wave transceiver as claimed in claim 1, wherein the pair of demodulators are connected to the common local oscillator and each one of the pair of modulators is connected to a different local oscillator.

5. A millimetre wave transceiver as claimed in claim 1, further comprising a circular polarizer between the orthomode transducer and the antenna.

6. A millimetre wave transducer as claimed in claim 5, wherein the orthomode transducer and the circular polarizer are integrated as a septum polarizer.

7. A millimetre wave transceiver as claimed in claim 1, comprising a plurality of the pair of modulators, each one of the pair of modulators being adapted to provide the transmit signal at the same frequency, each one of the plurality of pair of modulators being adapted to provide the transmit signal at a different frequency, wherein at least one of the plurality of the pair of modulators are connected to the common local oscillator.

8. A millimetre wave transceiver as claimed in claim 1, comprising a plurality of the pair of demodulators, each one of the pair of demodulators being adapted to receive signals at the same frequency from a corresponding one of the pair of ports of the multiplexer, each one of the plurality of the pair of demodulators being adapted to demodulate the receive signal at a different frequency, wherein for at least one of the plurality of the pair of demodulators are connected to the common local oscillator.

9. A millimetre wave transceiver as claimed in claim 1, wherein each transmit signal is amplified by an amplifier block prior to being passed to the multiplexer.

10. (canceled)

11. A millimetre wave transceiver comprising:
a multiplexer comprising a pair of transmit ports, a pair of receive ports and a pair of antenna ports;
an antenna;
an orthomode transducer connected between the pair of antenna ports and the antenna;
a pair of modulators each of which provides a transmit signal at the same frequency, each one of the pair of modulators adapted to receive a carrier signal from a local oscillator and a data signal and to modulate the carrier signal with the data signal to produce the transmit signal, each one of the pair of modulators being arranged to provide its transmit signal to a corresponding one of the pair of transmit ports of the multiplexer;
a pair of demodulators, each one of the pair of demodulators being adapted to receive a receive signal at the same frequency from a corresponding one of the pair of receive ports of the multiplexer and a reference signal from the local oscillator, and to demodulate the receive signal at a frequency related to the reference signal to obtain a data signal, wherein at least one of (a) the pair of modulators are connected to a common local oscillator; and (b) the pair of demodulators are connected to the common local oscillator;
a circular polarizer between the orthomode transducer and the antenna, wherein the orthomode transducer and the circular polarizer are integrated as a septum polarizer; and
wherein each transmit signal is amplified by an amplifier block prior to being passed to the multiplexer.
